(19) United States
(12) Patent Application Publication
(10) Pub. No.: US 2009/0246345 A1
(43) Pub. Date: Oct. 1, 2009

(54) Foamable Oil-in-Water Emulsion

(76) Inventors: Hiroyuki Ichiyama, Izumisano-shi (JP); Mihoko Inaba, Izumisano-shi (JP); Hiroshi Hidaka, Izumisano-shi (JP)

Correspondence Address: WENDEROTH, LIND & PONACK, L.L.P., 1030 15th Street, N.W.,, Suite 400 East, Washington, DC, 20005-1503, US

(21) Appl. No.: 11/887,255

(22) PCT Filed: Feb. 23, 2006
(86) PCT No.: PCT/JP2006/303216

§ 371 Date: Sep. 27, 2007

(30) Foreign Application Priority Data
Mar. 31, 2005 (JP) 2005-103657

(51) Int. Cl. A23D 7/00; A23L 1/19

(52) U.S. Cl. 426/564

(57) ABSTRACT

Disclosed is a foamable oil-in-water emulsion which has excellent feeling in the mouth, meltability in the mouth, and flavor and taste when whipped into a whip cream and also has high emulsion stability and whipping property. The foamable oil-in-water emulsion comprises an oil-and-fat component, a non-fat milk solid and water, in which the content of S2L-type triglyceride (wherein S means stearic acid and palmitic acid and L means linoleic acid) in the oil-and-fat component is 0.8 to 18% and is smaller than 8/900×(X−45)²+8 (wherein X represents the percentage of the oil-and-fat component, provided that it falls within the range of 10 to 45), and the content of S2L-type triglyceride in the foamable oil-in-water emulsion is as small as several percent or less, and the SFC of the oil-and-fat component falls within the range of 50 to 95 at 10° C.

### TECHNICAL FIELD

The present invention relates to a foamable oil-in-water emulsion used as a topping of a cake or the like, or used for a sandwiched cake (said emulsion is whipped to obtain whipped cream). More specifically, the present invention relates to a foamable oil-in-water emulsion which has an excellent feeling in the mouth, excellent meltability in the mouth, and an excellent flavor and taste when it is whipped, and also which has high emulsion stability and whipping property.

### BACKGROUND ART

Conventionally starch, an emulsifier, a viscous polysaccharide, cellulose or the like was used for improving the feeling in the mouth and meltability in the mouth of whipped cream. However, addition of a large amount of starch, an emulsifier, a viscous polysaccharide or cellulose was needed to obtain a significant feeling in the mouth or significant meltability in the mouth. For this reason, the flavor or taste of starch, an emulsifier, a viscous polysaccharide or cellulose itself influenced the feeling in the mouth and meltability in the mouth of whipped cream, and thus, whipped cream having the desired excellent flavor and taste could not be obtained. The patent document 1 discloses use of pullulan and cellulose. The patent document 2 discloses use of gelatin and carrageenan. The present inventors focus on oils and fats, and find that a foamable oil-in-water emulsion having an excellent feeling in the mouth, excellent meltability in the mouth, and an excellent flavor and taste when it is whipped can be provided by using a specific amount of a specific oil-and-fat in the range of a specific oil-and-fat content. The oil-and-fat component used in the present invention comprises S2L-type triglycerides (wherein S means stearic acid and palmitic acid, and L means linoleic acid). This kind of oil-and-fat component is used in the patent document 3 and the patent document 4. However the former provides a foamable oil-in-water emulsion having excellent emulsion stability which can be whipped in an extremely short time, and the latter provides an oil-in-water emulsion having a flavor and taste peculiar to chocolate. Both of the patent document 3 and the patent document 4 describe use of S2L-type triglycerides in larger amounts than that used in the present invention, and the used amount is not as small as used in the present invention. Further, the patent document 3 and the patent document 4 do not disclose an emulsion capable of providing whipped cream having such a feeling in the mouth, meltability in the mouth and flavor and taste as attained by the present invention.

Patent document 1: JP-A 7-236443
Patent document 2: JP-A 5-000063
Patent document 3: JP-A 6-98678
Patent document 4: JP-A 5-30911

### DISCLOSURE OF THE INVENTION

### Problems to be solved by the invention

An objective of the present invention is to provide a foamable oil-in-water emulsion which has an excellent feeling in the mouth, excellent meltability in the mouth and an excellent flavor and taste when it is whipped, and also which has high emulsion stability and whipping property.

### Means for Solving the Problems

The present inventors intensively studied and, as a result, attained the objective of the present invention by adding a specific amount, more specifically a small amount of a specific oil and fat, S2L-type triglycerides into an oil-and-fat component depending on the oil-and-fat content in an oil-in-water emulsion, resulting in completion of the present invention. The first aspect of the present invention is a foamable oil-in-water emulsion comprising an oil-and-fat component, a non-fat milk solid and water, in which the content of S2L-type triglycerides (wherein S means stearic acid and palmitic acid and L means linoleic acid) in the oil-and-fat component is 0.8 to 18%. The second aspect of the present invention is the foamable oil-in-water emulsion according to the first aspect, wherein the content of S2L-type triglycerides in the oil-and-fat component is smaller than 8/900×(X−45)²+8 (wherein X represents the percentage of the oil-and-fat component in the oil-in-water emulsion and falls within the range of 10 to 45). The third aspect of the present invention is the foamable oil-in-water emulsion according to the first or the second aspect, wherein the SFC of the oil-and-fat component falls within the range of 50 to 95 at 10° C.

### EFFECT OF THE INVENTION

According to the present invention, a foamable oil-in-water emulsion having an excellent feeling in the mouth, particularly a refreshing feeling in the mouth, excellent meltability in the mouth and an excellent flavor and taste when it is whipped, and also having high emulsion stability and whipping property can be provided.

### BEST MODE FOR CARRYING OUT THE INVENTION

The foamable oil-in-water emulsion of the present invention is an oil-in-water emulsion which comprises an oil-and-fat component, a non-fat milk solid and water and is in a flowable state, and also called “cream for whipping”. When the foamable oil-in-water emulsion is stirred using a whisk or a mixer for whipping so that air can be incorporated in the emulsion, it becomes a foamed state which is referred to as so-called “whipped cream” or “whip cream”.

The foamable oil-in-water emulsion of the present invention is an oil-in-water emulsion comprising an oil-and-fat component, a non-fat milk solid and water, wherein the content of S2L-type triglycerides (wherein S represents stearic acid St or palmitic acid P, and L represents linoleic acid) in the oil-and-fat component is as small as 0.8 to 18% and, preferably, the percentage (Y %) of S2L-type triglycerides in the oil-and-fat component is smaller than Y=8/900×(X−45)2+8 and larger than Y=8/900×(X−45)²+0.8, wherein X represents the percentage of the oil-and-fat component in the oil-in-water emulsion and 10<=X<=45. When the amount of S2L-type triglycerides is smaller, the effect of use of S2L-type triglycerides becomes poor. When the amount of S2L-type triglycerides is larger, the foamability of the oil-in-water emulsion is deteriorated, the shape-retainability of a product obtained by whipping the oil-in-water emulsion is deteriorated, or the feeling in the mouth of the product.

The S2L-type triglycerides as used in the present invention include SSL in which L is bound to the α-position, SLS in which L is bound to the β-position, and a mixture thereof, wherein S is a saturated fatty acid of stearic acid St or palmitic acid P, and L is a polyunsaturated fatty acid of linoleic acid, and preferred is SLS in which L is bound to the β-position.

The amount (Y) of S2L-type triglycerides is expressed by Y=Ys+Yp, wherein Ys represents the amount of St2L-type triglycerides and Yp represents the amount of P2L-type triglycerides.

The S2L-type triglyceride is obtained by transesterification of an oil-and-fat containing a large amount of linoleic acid, for example, safflower oil, sunflower oil, corn oil, rapeseed oil or soybean oil, inter alia, safflower oil or sunflower oil with a saturated fatty acid (stearic acid or palmitic acid)-rich ester or a fatty acid according to a known method, followed by fractionation if necessary.

Alternatively, it is preferable to use an S2L-containing oil-and-fat containing S2L-type triglycerides in high concentration, preferably in a concentration of 40% or more, which is obtained by fractionation of an oil-and-fat containing a large amount of S2L-type triglycerides such as cottonseed oil.

In the present invention, the S2L-type triglyceride is used as an additive. The amount added of S2L-type triglycerides is approximately a few % or lower, preferably 0.4 to 4.0%, more preferably 0.4 to 3.5%, most preferably 0.4 to 3.0% of the whole foamable oil-in-water emulsion.

The amount added of S2L-type triglycerides, however, varies within the range of the percentage (X %) of the oil-and-fat component in the foamable oil-in-water emulsion (hereinafter referred to as “oil-and-fat content (X %)”). It should be appreciated that, as described above, it is preferable that the percentage (Y %) of S2L-type triglycerides in the oil-and-fat component is smaller than Y=8/900×(X−45)²+8 and larger than Y=8/900×(X−45)²+0.8, wherein X represents the percentage of the oil-and-fat component in the oil-in-water emulsion and 10<=X<=45.

As the S2L-type triglycerides, a S2L-containing oil-and-fat which contains S2L-type triglycerides in high concentration is preferably used. It is preferable that 40% or more of S2L-type triglycerides contained in the whole oil-and-fat component are derived from the S2L-containing oil-and-fat.

The oil-and-fat content (X %) in the foamable oil-in-water emulsion of the present invention is 10 to 45%, preferably 12 to 45%, more preferably 15 to 45%. When the oil-and-fat content exceeds the upper limit, the foamable oil-in-water emulsion is easily plasticized. When the oil-and-fat content is below the lower limit, the foamability of the foamable oil-in-water emulsion and the shape-retainability of a product obtained by whipping the foamable oil-in-water emulsion tend to be deteriorated.

The content (Y %) of S2L-type triglycerides in the oil-and-fat component is smaller than Y=8/900×(X−45)²+8 and larger than Y=8/900×(X−45)²+0.8, wherein the oil-and-fat component content (X %) in the oil-in-water emulsion is in the range of 10 to 45%. It is preferable that Y % is smaller than Y=8/900×(X−45)²+8, more preferably smaller than Y=1/160×(X−45)²+8.

The above equations mean that the content of S2L-type triglycerides in the whole oil-and-fat component is small, and also means that the S2L-type triglyceride content is high in an emulsion having an oil-and-fat content as low as 10 to 30% and is low in an emulsion having an oil-and-fat content as high as 30 to 45% although the S2L-type triglyceride content is small.

When Y % is larger than Y=8/900×(X−45)²+8, the foamability of the emulsion having low oil-and-fat content and the shape-retainability of a product obtained by whipping the emulsion having low oil-and-fat content are deteriorated, and a product obtained by whipping the emulsion having high oil-and-fat content has a heavy feeling in the mouth. On the other hand, when Y % is smaller than Y=8/900×(X−45)²+8, the effect of use of the S2L-type triglycerides becomes poor.

The above equations show a relationship between X % (the oil-and-fat content) and Y % (the S2L-type triglyceride content in the oil-and-fat component), and are empirical rules based on experimental values obtained by repeating trial and error many times.

It is preferable that the oil-and-fat component in the foamable oil-in-water emulsion of the present invention has SFC of 50 to 95 at 10° C. When the SFC of the oil-and-fat component is lower, the foamability of the oil-in-water emulsion and the shape-retainability of a product obtained by whipping the oil-in-water emulsion tend to be deteriorated. When the SFC of the oil-and-fat component is higher, the feeling in the mouth of a product obtained by whipping the oil-in-water emulsion becomes heavy.

Examples of an oil-and-fat having SFC of 50 to 95 at 10° C. include an animal or vegetable oil or fat, a hydrogenated oil or fat thereof, a mixture thereof, and a processed oil or fat obtained by subjecting the above-mentioned oils and fats to various chemical or physical treatments, as well as the oil-and-fat containing S2L-type triglycerides as described above. Specific examples of such oil-and-fat having SFC of 50 to 95 at 10° C. include various animal or vegetable oils and fats such as soybean oil, cottonseed oil, corn oil, safflower oil, olive oil, palm oil, rapeseed oil, rice bran oil, sesame oil, kapok oil, coconuts oil, palm kernel oil, milk fat, lard, fish oil, whale oil and the like, and processed oils and fats obtained by hydrogenation, fractionation, transesterization or the like of the above-mentioned oils and fats.

The milk fat as used in the present invention includes not only a milk fat derived form milk such as cow milk, fresh cream, butter or the like, but also butter oil which is obtained by subjecting cow milk, fresh cream, butter or the like as a raw material to processing treatment.

Measurement of the SFC (solid fat content) of an oil-and-fat was performed in conformity with IUPAC2.150 (Solid Content Determination in Fats by NMR).

The non-fat milk solid as used in the present invention refers to a component remaining after removing a milk fat component from the whole solid component of milk, and examples thereof include raw materials derived from milk such as raw milk, cow milk, defatted milk, fresh cream, concentrated milk, sugarless condensed milk, sugar-added condensed milk, whole fat milk powder, defatted milk powder, butter milk powder, whey protein, casein, sodium caseinate and the like. The oil-in-water emulsion of the present invention comprises preferably 1 to 14 wt %, more preferably 2 to 12 wt %, most preferably 4 to 10 wt % of the non-fat milk solid. When the non-fat milk solid content is smaller, the oil-in-water emulsion has deteriorated emulsion stability, and also has a decreased milk taste, resulting in deterioration in the flavor and taste. When the non-fat milk solid content is larger, the viscosity of the oil-in-water emulsion is increased and the cost for preparing the oil-in-water emulsion is also increased, so that it is difficult to obtain an effect commensurate with the amount used of the non-fat milk solid.

The foamable oil-in-water emulsion of the present invention may contain an emulsifier, a salt, a saccharide, a stabilizer, a flavor, a coloring material, or a preservative. Examples of the saccharide include starch, a starch degradation product, an oligosaccharide, a disaccharide, a monosaccharide, sugar alcohol, cellulose, inulin and the like, and these are preferably used alone or as a mixture of two or more kinds. Further, for reducing sweetness and obtaining a refreshing flavor and taste, it is preferable that the saccharide is one or more selected from starch, a starch degradation product, an oligosaccharide, cellulose and inulin.

As the emulsifier in the present invention, a conventional emulsifier used for preparing a foamable oil-in-water emulsion can be used as appropriate. Examples of the emulsifier include synthetic emulsifiers such as lecithin, monoglyceride, a sorbitan fatty acid ester, a propylene glycol fatty acid ester, a polyglycerin fatty acid ester, a polyoxyethylene sorbitan fatty acid ester, a sucrose fatty acid ester and the like, and one or more of them can be selected and then used as appropriate.

The foamable oil-in-water emulsion of the present invention preferably contains a salt. Various salts can be used as the salt, and it is preferable that hexametaphosphate, dibasic phosphate, sodium citrate, polyphosphate, sodium bicarbonate and the like are used alone or as a mixture of two or more kinds.

The foamable oil-in-water emulsion of the present invention has overrun of 50 to 140%, preferably 60 to 130%, more preferably 70 to 110%. When the overrun is too high, a product obtained by whipping the foamable oil-in-water emulsion tends to have a too light feeling in the mouth or a poor flavor and taste. When the overrun is too low, it is difficult to obtain a whipped product having the desired flavor and taste and the desired meltability feeling in the mouth which are the objectives of the present invention from the foamable oil-in-water emulsion.

It is presumed that using the specific S2L-type triglycerides as oils and fats for preparation of a foamable oil-in-water emulsion as described above probably results in the formation of specific crystal structure, and thereby the obtained foamable oil-in-water emulsion has high emulsion stability and good whipping property, and a whipped product in a foamed state which is obtained by whipping the foamable oil-in-water emulsion is excellent in feeling in the mouth, meltability in the mouth, and flavor and taste.

The foamable oil-in-water emulsion of the present invention can be produced by mixing the main raw materials of an oil-and-fat component, a non-fat milk solid and water with materials such as an emulsifier, a salt and the like as appropriate, followed by pre-emulsification, pasteurization or sterilization, and homogenization. It is preferable to perform sterilization from a viewpoint of preservation of the foamable oil-in-water emulsion. Specifically, raw materials are pre-emulsified at 60 to 70° C. for 20 minutes (with an emulsification device: homomixer) and then, if necessary, homogenized under the condition of 0 to 250 Kg/cm² (with an emulsification device: homogenizer). Then, the pre-emulsified (and if necessary, homogenized) raw materials is subjected to an ultrahigh temperature instantaneous sterilization treatment (UHT), homogenized again under the condition of 0 to 300 Kg/cm², cooled, and then aged for about 24 hours.

There are two types of ultrahigh temperature instantaneous (UHT) sterilization, that is, an indirect heating mode and a direct heating mode. Examples of an apparatus for the indirect heating treatment include, but not limited to, an APV plate-type UTH treatment apparatus (manufactured by APV Co., Ltd.), a CP-UHT sterilization apparatus (manufactured by Climaty Package Co., Ltd.), a Stork tubular-type sterilization apparatus (manufactured by Stork), a Contherm scraping-type UHT sterilization apparatus (manufactured by Tetrapak Alfa Laval) and the like. Examples of the direct heating-type sterilization apparatus include an ultrahigh temperature sterilization apparatus (manufactured by IWAI KIKAI KOGYO CO., LTD), a uperization sterilization apparatus (manufactured by Tetrapak Alfa Laval), a VTIS sterilization apparatus (manufactured by Tetrapak Alfa Laval), a Lagear UHT sterilization apparatus (manufactured by Lagear), a Paralizator (manufactured by Pash and Silkeborg) and the like, and any of these apparatuses may be used.

### EXAMPLES

The present invention well be explained in more detail by reference to Examples, but the sprit of the present invention is not limited to the following Examples. In Examples, “%” and “part” are by weight. Particularly, it goes without saying that the order of addition of additives, or the order of emulsification, for example, the order of adding an oil phase to an aqueous phase or adding an aqueous phase to an oil phase is not limited by the following Examples. Results were assessed by the following method.

[A] Test for Plasticization of an Oil-in-Water Emulsion (Stability of an Oil-in-Water Emulsion)

Plasticization test: Fifty grams of an oil-in-water emulsion was put into a 100 ml-volume beaker, incubated at 20° C. for 2 hours and then shaken for 5 minutes using a horizontal shaker. After that, the presence or absence of plasticization of the oil-in-water emulsion was checked.

[B] Method of Assessment of a Product Obtained by Whipping an Oil-in-Water Emulsion

(1) Whipping time: Time until an oil-in-water emulsion reaches the optimal foamed state when a mixture of 1 kg of an oil-in-water emulsion and 80 g of granulated sugar is whipped with a HOBART mixer (MODEL N-5 manufactured by HOBART CORPORATION) at the third gear (300 rpm).

(2) Overrun: [(Weight of oil-in-water emulsion per given volume)−(weight of foamed product after whipping per given volume)]/(weight of foamed product after whipping per given volume)×100

(3) Shape-retainability and water release: Fineness of a flower-shaped foamed product after storage at 15° C. for 24 hours is assessed on a scale of “very good”, “good” and “not good”.

(4) Flavor and taste, feeling in the mouth, and meltability in the mouth: Twenty professional panelists assessed them on a scale of “very good”, “good” and “not good”. The averaged assessment was adopted as a result.

### Experimental Example 1

### Preparation of S2L-Containing Oil-and-Fat (1)

A mixture of 20 parts of safflower oil and 80 parts of stearic acid was subjected to transesterization with a 1,3-position-specific lipase, and then an ethyl ester fraction was removed by distillation to obtain an S2L-containing oil-and-fat (1).

### Experimental Example 2

### Preparation of S2L-Containing Oil-and-Fat (2)

A mixture of cottonseed oil:acetone=20:80 was melted, cooled to −10° C. while stirring, and then kept for 30 minutes to precipitate a crystal. After that, the mixture was filtered under reduced pressure to fractionate it into a crystal fraction and a liquid fraction.

Acetone was removed from the resulting crystal fraction by a conventional method, and the fraction was decolored and deodorized by a conventional method to obtain an S2L-containing oil-and-fat (2).

### Experimental Example 3

The St2L amount and the P2L amount of the S2L-containing oil-and-fat (1), the S2L-containing oil-and-fat (2), a palm medium melting point fraction, a soybean-palm mixed hardened oil, or a rapeseed-palm mixed hardened oil, which was used for preparation of a foamable oil-in-water emulsion, were measured using a liquid chromatography method and a gas chromatography method. Results are summarized in Table 1.

TABLE 1

| | St2L | P2L |
|---|---|---|
| S2L-contaning oil-and-fat (1) | 43.0% | 1.0% |
| S2L-conatining oil-and-fat (2) | 54.0% | — |
| Palm medium melting point fraction | — | 7.0% |
| (melting point 34° C.) | | |
| Soybean-palm mixed hardened oil | — | 0.6% |
| Rapeseed-palm mixed hardened oil | — | 0.5% |

### Example 1

To a mixture of 13 parts of a palm medium melting point fraction (melting point 34° C.) and 2 parts of the S2L-containing oil-and-fat (1) were added 0.2 parts of lecithin and 0.1 parts of a glycerin fatty acid ester, mixed and then melted to obtain an oil phase. Into 68.9 parts of water were dissolved 5.5 parts of defatted milk powder, 10 parts of dextrin, 0.1 parts of sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. Although the emulsion had an oil-and-fat content as low as 15 wt %, the foamed product obtained from the emulsion had a refreshing feeling in the mouth. Results are summarized in Table 2. The oil-and-fat content and the S2L-type triglyceride content of the emulsion of Example 1 are shown as a graph in FIG. 1.

### Example 2

To a mixture of 9 parts of a palm medium melting point fraction (melting point 34° C.), 18 parts of a purified coconut oil, 4 parts of a rapeseed-palm mixed hardened oil and 4 parts of the S2L-containing oil-and-fat (1) was added 0.1 parts of lecithin, mixed and then melted to obtain an oil phase. Into 58.9 parts of water were dissolved 5.5 parts of defatted milk powder, 0.3 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. The foamed product had a refreshing feeling in the mouth and a pleasant milk taste. Results are summarized in Table 2. The oil-and-fat content and the S2L-type triglyceride content of the emulsion of Example 2 are shown as a graph in FIG. 1.

### Example 3

To a mixture of 5.5 parts of a palm medium melting point fraction (melting point 34° C.), 5.5 parts of a hardened coconut oil, 5 parts of a rapeseed-palm mixed hardened oil, 1 part of the S2L-containing oil-and-fat (1) and 20 parts of a milk fat were added 0.2 parts of lecithin and 0.1 parts of a glycerin fatty acid ester, mixed and then melted to obtain an oil phase. Into 56.8 parts of water were dissolved 5.5 parts of defatted milk powder, 0.2 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained form the emulsion were very good. The foamed product had a refreshing feeling in the mouth and a pleasant milk taste. Results are summarized in Table 2. The oil-and-fat content and the S2L-type triglyceride content of the emulsion of Example 3 are shown as a graph in FIG. 1.

### Example 4

To a mixture of 9 parts of a palm medium melting point fraction (melting point 34° C.), 8 parts of a hardened coconut oil, 4 parts of a rapeseed-palm mixed hardened oil, 4 parts of the S2L-contained oil-and-fat (2) and 15 parts of a milk fat were added 0.1 parts of lecithin and 0.05 parts of a glycerin fatty acid ester, mixed and then melted to obtain an oil phase. Into 54.0 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. The foamed product had a refreshing feeling in the mouth and a pleasant milk taste. Results are summarized in Table 2. The oil-and-fat content and the S2L-type triglyceride content of the emulsion of Example 4 are shown as a graph in FIG. 1.

### Example 5

To a mixture of 9 parts of a palm melting point fraction (melting point 34° C.), 8 parts of a hardened coconut oil, 5.5 parts of a rapeseed-palm mixed hardened oil, 2.5 parts of the S2L-containing oil-and-fat (1) and 15 parts of a milk fat were added 0.1 parts of lecithin and 0.05 parts of a glycerin fatty acid ester, mixed and then melted to obtain an oil phase. Into 54.0 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. The foamed product had a refreshing feeling in the mouth and a pleasant milk taste. Results are summarized in Table 2. The oil-and-fat content and the S2L-type triglyceride content of the emulsion of Example 5 are shown as a graph in FIG. 1.

### Example 6

To a mixture of 3 parts of a palm medium melting point fraction (melting point 34° C.), 3.5 parts of a hardened coconut oil, 3 parts of a rapeseed-palm mixed hardened oil, 0.5 parts of the S2L-containing oil-and-fat (1) and 31 parts of a milk fat were added 0.1 parts of lecithin and 0.05 parts of a glycerin fatty acid ester, mixed and then melted to obtain an oil phase. Into 52.7 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. The foamed product had a refreshing feeling in the mouth and a pleasant milk taste. Results are summarized in Table 2. The oil-and-fat content and the S2L-type triglyceride content of the emulsion of Example 6 are shown as a graph in FIG. 1.

### Example 7

To a mixture of 2.5 parts of a palm medium melting point fraction (melting point 34° C.), 3 parts of a hardened coconut oil, 2.5 parts of a rapeseed-palm mixed hardened oil, 2 parts of the S2L-containing oil-and-fat (1) and 31 parts of a milk fat were added 0.1 parts of lecithin and 0.05 parts of a glycerin fatty acid ester, mixed and then melted to obtain an oil phase. Into 53.0 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. The foamed product had a refreshing feeling in the mouth and a pleasant milk taste. Results are summarized in Table 2. The oil-and-fat content and the S2L-type triglyceride content of the emulsion of Example 7 are shown as a graph in FIG. 1.

### Example 8

To a mixture of 24 parts of a soybean-palm mixed hardened oil, 10 parts of a purified coconut oil, 1 part of the S2L-containing oil-and-fat (1) and 10 parts of a milk fat was added 0.3 parts of lecithin, mixed and then melted to obtain an oil phase. Into 48.9 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. Although the emulsion had an oil-and-fat content as high as 45%, a foamed product obtained from the emulsion was not sticky and had a refreshing feeling in the mouth. Results are summarized in Table 2. The oil-and-fat content and the S2L-type triglyceride content of the emulsion of Example 8 are shown as a graph in FIG. 1.

Table 2 shows the results of Examples 1 to 8.

TABLE 2

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Oil phase | | | | | | | | |
| Palm medium melting point fraction | 13 | 9 | 5.5 | 9 | 9 | 3 | 2.5 | — |
| (m.p. 34° C.) | | | | | | | | |
| Soybean-palm mixed hardened oil | — | — | — | — | — | — | — | 24 |
| Purified coconut oil | — | 18 | — | — | — | — | — | 10 |
| Hardened coconut oil | — | — | 5.5 | 8 | 8 | 3.5 | 3 | — |
| Rapeseed-palm mixed hardened oil | — | 4 | 5 | 4 | 5.5 | 3 | 2.5 | — |
| S2L-containig oil-and-fat (1) | 2 | 4 | 1 | — | 2.5 | 0.5 | 2.0 | 1 |
| S2L-containig oil-and-fat (2) | — | — | — | 4 | — | — | — | — |
| Milk fat | — | — | 20 | 15 | 15 | 31 | 31 | 10 |
| Lecithin | 0.2 | 0.1 | 0.2 | 0.1 | 0.1 | 0.1 | 0.1 | 0.3 |
| Glycerin fatty acid ester | 0.1 | — | 0.1 | 0.05 | 0.05 | 0.05 | 0.05 | — |
| (HLB 8) | | | | | | | | |
| Aqueous phase | | | | | | | | |
| Water | 68.9 | 58.9 | 56.8 | 54.0 | 54.0 | 52.7 | 53.0 | 48.9 |
| Defatted milk powder | 5.5 | 5.5 | 5.5 | 5.5 | 5.5 | 5.5 | 5.5 | 5.5 |
| Dextrin | 10 | — | — | — | — | — | — | — |
| Sucrose fatty acid ester | 0.1 | 0.3 | 0.2 | 0.15 | 0.15 | 0.15 | 0.15 | 0.15 |
| (HLB 5) | | | | | | | | |
| Sodium citrate | 0.2 | 0.2 | 0.2 | 0.2 | 0.2 | 0.2 | 0.2 | 0.2 |
| Oil-and-fat content (%) | 15 | 35 | 37 | 40 | 40 | 41 | 41 | 45 |
| S2L-tyep triglyceride content (%) in | 11.9 | 6.9 | 2.3 | 7.0 | 4.4 | 1.1 | 2.6 | 1.2 |
| oil-and-fat component | | | | | | | | |
| SFC (10° C.) | 86.8 | 73.7 | 59.2 | 64.1 | 64.0 | 55.2 | 52.7 | 63.3 |
| S2L-type triglyceride content (%) in | 1.8 | 2.4 | 0.85 | 2.8 | 1.8 | 0.45 | 1.1 | 0.54 |
| oil-in-water emulsion | | | | | | | | |
| Plasticization | Absence | Absence | Absence | Absence | Absence | Absence | Absence | Absence |
| Whipping time (min., sec.) | 3′00″ | 2′30″ | 1′35″ | 2′00″ | 2′20″ | 1′10″ | 1′10″ | 2′03″ |
| Overrun (%) | 96 | 110 | 95 | 100 | 89 | 83 | 83 | 100 |
| Shape retainability at 15° C. (flower- | VG | VG | VG | VG | VG | VG | VG | VG |
| shape retaining property) | | | | | | | | |
| Water release at 15° C. | VG | VG | VG | VG | VG | VG | VG | VG |
| Flavor and taste | VG | VG | VG | VG | VG | VG | VG | VG |
| Feeling in the mouth | VG | VG | VG | VG | VG | VG | VG | VG |
| Meltability in the mouth | VG | VG | VG | VG | VG | VG | VG | G |

VG: Very Good,
G: Good

### Comparative Example 1

To 15 parts of a palm medium melting point fraction (melting point 34° C.) were added 0.2 parts of lecithin and 0.1 parts of a glycerin fatty acid ester, mixed and then melted to obtain an oil phase. Into 68.9 parts of water were dissolved 5.5 parts of defatted milk powder, 10 parts of dextrin, 0.1 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste of a foamed product obtained from the emulsion were very good. However the feeling in the mouth and the meltability in the mouth of the foamed product were not good. Results are summarized in Table 3. The oil-and-fat content and the S2L-type triglyceride content of the emulsion of Comparative Example 1 are shown as a graph in FIG. 1.

### Comparative Example 2

To a mixture of 10 parts of a palm medium melting point fraction (melting point 34° C.) and 5 parts of the S2L-containing oil-and-fat (1) were added 0.2 parts of lecithin and 0.1 parts of a glycerin fatty acid ester, mixed and then melted to obtain an oil phase. Into 68.9 parts of water were dissolved 5.5 parts of defatted milk powder, 10 parts of dextrin, 0.1 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste, the feeling in the mouth, and the meltability in the mouth of a foamed product obtained from the emulsion were very good. However, the shape-retainability and water release at 15° C. of the foamed product were not good. Results are summarized in Table 3. The oil-and-fat content and the S2L-type triglyceride content of the emulsion of Comparative Example 2 are shown as a graph in FIG. 1.

### Comparative Example 3

To a mixture of 8 parts of a palm medium melting point fraction (melting point 34° C.), 16.5 parts of a purified coconut oil, 3.5 parts of a rapeseed-palm mixed hardened oil and 7 parts of the S2L-containing oil-and-fat (1) was added 0.1 parts of lecithin, mixed and then melted to obtain an oil phase. Into 58.9 parts of water were dissolved 5.5 parts of defatted milk powder, 0.3 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste and the meltability in the mouth of a foamed product obtained from the emulsion were very good. However, the feeling in the mouth of the foamed product was heavy and not good. Results are summarized in Table 3. The oil-and-fat content and the S2L-type triglyceride content of the emulsion of Comparative Example 3 are shown as a graph in FIG. 1.

### Comparative Example 4

To a mixture of 6.5 parts of a hardened coconut oil, 3 parts of a rapeseed-palm mixed hardened oil, 0.5 parts of the S2L-containing oil-and-fat (1) and 31 parts of a milk fat were added 0.1 parts of lecithin and 0.05 parts of a glycerin fatty acid ester, mixed and then melted to obtain an oil phase. Into 53.0 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste and the meltability in the mouth of a foamed product obtained from the emulsion were very good. However, the feeling in the mouth of the foamed product was not refreshing and not good. Results are summarized in Table 3. The oil-and-fat content and the S2L-type triglyceride content of the emulsion of Comparative Example 4 are shown as a graph in FIG. 1.

### Comparative Example 5

To a mixture of 24 parts of a soybean-palm mixed hardened oil, 10.5 parts of a purified coconut oil, 0.5 parts of the S2L-containing oil-and-fat (1) and 10 parts of a milk fat was added 0.3 parts of lecithin, mixed and then melted to obtain an oil phase. Into 48.9 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste and the meltability in the mouth of a foamed product obtained from the emulsion were very good. However, the feeling in the mouth of the foamed product was not refreshing and not good. Results are summarized in Table 3. The oil-and-fat content and the S2L-type triglyceride content of the emulsion of Comparative Example 5 are shown as a graph in FIG. 1.

### Comparative Example 6

To a mixture of 18 parts of a soybean-palm mixed hardened oil, 8 parts of a purified coconut oil, 9 parts of the S2L-containing oil-and-fat (1) and 10 parts of a milk fat was added 0.3 parts of lecithin, mixed and then melted to obtain an oil phase. Into 48.9 parts of water were dissolved 5.5 parts of defatted milk powder, 0.15 parts of a sucrose fatty acid ester and 0.2 parts of sodium citrate to prepare an aqueous phase. The oil phase and the aqueous phase were pre-emulsified by stirring with a homomixer at 65° C. for 30 minutes, sterilized at 145° C. for 4 seconds in a direct heating mode with an ultrahigh temperature sterilization apparatus (manufactured by IWAI KIKAI KOGYO CO., LTD), homogenized at a homogenization pressure of 100 Kg/cm², and then immediately cooled to 5° C. After cooling, aging for about 24 hours afforded a foamable oil-in-water emulsion. The emulsion was assessed according to the above-described whipping method. The flavor and taste and the meltability in the mouth of a foamed product obtained from the emulsion were very good. However, the feeling in the mouth of the foamed product was heavy and not good. Results are summarized in Table 3. The oil-and-fat content and the S2L-type triglyceride content of the emulsion of Comparative Example 6 are shown as a graph in FIG. 1.

Table 3 shows the results of Comparative Examples 1 to 6.

TABLE 3

| | Comp. Ex. 1 | Comp. Ex. 2 | Comp. Ex. 3 | Comp. Ex. 4 | Comp. Ex. 5 | Comp. Ex. 6 |
|---|---|---|---|---|---|---|
| Oil phase | | | | | | |
| Palm medium melting point fraction (m.p. 34° C.) | 15 | 10 | 8 | — | — | — |
| Soybean-palm mixed hardened oil | — | — | — | — | 24 | 18 |
| Purified coconut oil | — | — | 16.5 | — | 10.5 | 8 |
| Hardened coconut oil | — | — | — | 6.5 | — | — |
| Rapeseed-palm mixed hardened oil | — | — | 3.5 | 3 | — | — |
| S2L-contaning oil-and-fat (1) | — | 5 | 7 | 0.5 | 0.5 | 9 |
| S2L-contaning oil-and-fat (2) | — | — | — | — | — | — |
| Milk fat | — | — | — | 31 | 10 | 10 |
| Lecithin | 0.2 | 0.2 | 0.1 | 0.1 | 0.3 | 0.3 |
| Glycerin fatty acid ester (HLB 8) | 0.1 | 0.1 | — | 0.05 | — | — |
| Aqueous phase | | | | | | |
| Water | 68.9 | 68.9 | 58.9 | 53.0 | 48.9 | 48.9 |
| Defatted milk powder | 5.5 | 5.5 | 5.5 | 5.5 | 5.5 | 5.5 |
| Dextrin | 10 | 10 | — | — | — | — |
| Sucrose fatty acid ester (HLB 5) | 0.1 | 0.1 | 0.3 | 0.15 | 0.15 | 0.15 |
| Sodium citrate | 0.2 | 0.2 | 0.2 | 0.2 | 0.2 | 0.2 |
| Oil-and-fat content (%) | 15 | 15 | 35 | 41 | 45 | 45 |
| S2L-type triglyceride content (%) in oil-and- | 7.0 | 19.3 | 10.5 | 0.6 | 0.7 | 9.0 |
| fat component | | | | | | |
| SFC (10° C.) | 93.1 | 78.8 | 71.6 | 56.6 | 63.0 | 61.2 |
| Plasticization | Absence | Absence | Absence | Absence | Absence | Absence |
| Whipping time (min., sec.) | 4′10″ | 2′55″ | 2′05″ | 1′20″ | 2′15″ | 2′15″ |
| Overrun (%) | 105 | 90 | 105 | 87 | 98 | 98 |
| Shape retainability at 15° C. (flower-shape | VG | NG | VG | VG | VG | VG |
| retaining property) | | | | | | |
| Water release at 15° C. | VG | NG | VG | VG | VG | VG |
| Flavor and taste | VG | VG | VG | VG | VG | VG |
| Feeling in the mouth | NG | VG | NG | NG | NG | NG |
| Meltability in the mouth | NG | VG | VG | VG | G | G |

VG: Very Good;
G: Good;
NG: Not Good

### INDUSTRIAL APPLICABILITY

The present invention relates to a formable oil-in-water emulsion which has an excellent feeling in the mouth, excellent meltability in the mouth, and an excellent flavor and taste when it is whipped, and also which has high emulsion stability and whipping property.

### BRIEF DESCRIPTION OF DRAWINGS

FIG. 1 shows oil-and-fat content, and S2L-type triglyceride content in an oil-and-fat component.

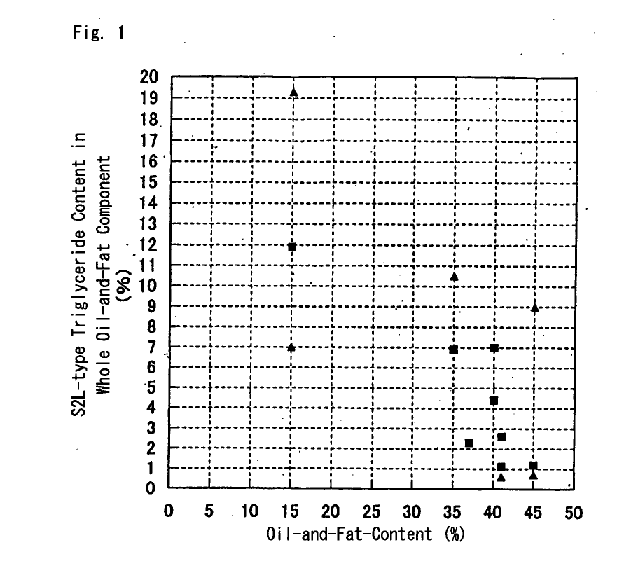

1. A foamable oil-in-water emulsion comprising an oil-and-fat component, a non-fat milk solid and water, wherein the content of S2L-type triglycerides (wherein S means stearic acid and palmitic acid, and L means linoleic acid) in the oil-and-fat component is 0.8 to 18%.

2. The foamable oil-in-water emulsion according to claim 1, wherein the content of the S2L-type triglycerides in the oil-and-fat component is smaller than 8/900×(X−45)²+8 (wherein X represents the percentage of the oil-and-fat component in the oil-in-water emulsion and falls within the range of 10 to 45).

3. The foamable oil-in-water emulsion according to claim 1, wherein the SFC of the oil-and-fat component falls within the range of 50 to 95 at 10° C.

4. The foamable oil-in-water emulsion according to claim 2, wherein the SFC of the oil-and-fat component falls within the range of 50 to 95 at 10° C.
